(19) United States
(12) Patent Application Publication
(10) Pub. No.: US 2004/0020131 A1
(43) Pub. Date: Feb. 5, 2004

(54) Slider window assembly

(76) Inventors: Jim Galer, Hudsonville, MI (US); Niall R. Lynam, Holland, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/454,040

(22) Filed: Jun. 4, 2003

Related U.S. Application Data
(63) Continuation-in-part of application No. 10/408,047, filed on Apr. 4, 2003.
(60) Provisional application No. 60/372,336, filed on Apr. 12, 2002.

(51) Int. Cl. E06B 3/32

(52) U.S. Cl. 49/413

(57) ABSTRACT

A vehicular power slider window assembly includes a fixed pane, with an opening formed at a generally central portion of the fixed pane, a sliding pane that is adapted for movement over the opening to thereby open and close the opening, a guide for guiding the sliding pane, and a drive assembly for moving said sliding pane over said opening. The drive assembly and guide are mounted to the window assembly inboard of the perimeter edge of the fixed pane wherein the power slider window assembly comprises a self-contained, modular power slider window assembly unit.

This application is a continuation-in-part application of U.S. patent application Ser. No. 10/408,047, entitled SLIDER WINDOW ASSEMBLY by Jim Galer (Attorney Docket DON02 P1083), filed Apr. 4, 2003, which is incorporated by reference herein in its entirety.

### TECHNICAL FIELD AND BACKGROUND OF THE INVENTION

The present invention relates to a window assembly and, more particularly, to a power slider window assembly that is particularly suitable for mounting in a rear opening of a vehicle, such as in a rear opening of a light truck, such as a pick-up truck.

Conventional slider window assemblies for rear openings in trucks or the like typically include three or more panes—two fixed panes and at least one sliding pane. The fixed panes are supported in a spaced relationship, for example, by a support, such as a frame. The sliding pane (or panes) is supported by rails, which are typically mounted to the support.

Some slider assemblies incorporate drive assemblies to move the sliding pane (or panes) between their respective open and closed positions. The drive assemblies are typically assembled from a plurality of components. For example, in a cable drive system there may be one or more cable sections, cable mounts for anchoring the cable to the sliding pane, cable guides, pulleys, a motor, and a drive drum. The components are typically post-attached to the window assembly after the window assembly has been assembled, but typically require the mounting of one or more components in the vehicle body. Hence these powered slider window assemblies tend to be cumbersome to handle when fully equipped with the drive assembly components and hence cumbersome to install. In addition, such conventional powered slider window assemblies, such as powered backlite slider window assemblies, typically need external modifications or adjustments to the frame opening into which the glazing element of the window assembly fits to make accommodations for the motive elements of the window assembly.

Consequently, there is a need for a simpler slider window assembly that is easier to manufacture and install and, further, that can provide a flush mounting arrangement.

### SUMMARY OF THE INVENTION

Accordingly, the present invention provides a simplified power slider window assembly that is easier to handle and install than known powered slider window assemblies and, further, that provides a self-contained power slider window assembly unit that can be mounted in a vehicle.

In one form of the invention, a vehicle power slider window assembly includes a fixed pane, a sliding pane, which is movably mounted to the fixed pane to open and close an opening formed in the fixed pane, a drive assembly for selectively moving the sliding pane to open and close the opening, and a guide for guiding the sliding pane. The guide and the drive assembly are mounted to the window assembly inboard of the window assembly perimeter so as to provide a self-contained power slider window assembly unit that is easier to handle and install.

In one aspect, the sliding window pane is mounted to the fixed pane by a pair of rails. For example, the rails may comprise generally horizontal rails, with the sliding pane mounted for generally horizontal movement.

In other aspects, the drive assembly comprises a driver and a driven element. For example, the driver may be mounted to the sliding pane or may be mounted to the fixed pane or in or on one of the rails. With a horizontal sliding pane the driver may be mounted at or near the upper or lower rail, with the driven element mounted to the sliding pane. Alternately, as noted above, the driver may be mounted to the sliding pane, with the driven element mounted in a fixed position, such as in the rail. Similarly, with a horizontal sliding pane, the driver may be mounted at the upper end of the sliding pane to engage a driven element mounted in the upper rail or may be mounted at the lower end of the sliding pane to engage a driven element supported in the lower rail.

In further aspects, the driver may comprise a motor and drive gear that drives, for example, a driven element, such as a rack or worm gear. As noted above, the rack or worm gear may be positioned in or on one of the rails or may be mounted to the sliding pane.

In other aspects, the sliding pane is mounted for movement between a plurality of open positions and a closed position, with the sliding pane moving into the opening substantially flush with the fixed pane when moved to its closed position. For example, the rails may be adapted to guide the sliding pane in a lateral direction relative to the direction of the sliding movement of the sliding pane to move the sliding pane to its closed position wherein the sliding pane is substantially flush with the fixed pane. For example, the rails may include guide surfaces that guide the sliding pane to its substantially flush, closed position. When moved to its closed position within the opening, the sliding pane is preferably sealed therein by, for example, one or more seals that are mounted to the fixed pane at the opening or to the sliding pane or both. In this manner, when the sliding pane is moved into its closed position within the opening, the sliding pane preferably presses against the seal or seals to thereby provide a full circumference seal around the sliding pane.

According to other aspects, the rails are inboard from the perimeter of the fixed pane. Optionally, the rails may comprise plastic rails, metal rails, composite rails, or the like, which are bonded or otherwise mounted to the inner surface of the fixed pane preferably inboard from the perimeter edge of the fixed pane. Optionally, the inner peripheral surface of the fixed pane may include a frit layer that extends around the periphery of the fixed pane, with the rails located in board of the peripheral edge of the fixed pane but preferably generally within the frit layer region so that the rails are not readily visible from outside of the vehicle when the window assembly is mounted in the vehicle.

For example, the rails may comprise channel-shaped or L-shaped members and, further, include seals for sealingly engaging the sliding pane. Furthermore, the rails may be interconnected by one or more support members. Optionally, the support members and the rails may be formed, such as by molding, into an assembly prior to mounting the rails and support member(s) onto the fixed pane to ease manufacture of the window assembly. The support members may also include seals for sealing against the sliding pane. Alternately, the seals may be directly mounted on the fixed pane around the opening.

In addition, the fixed pane preferably includes a perimeter edge that is free of attachment such that the window assembly appears to be a floating window when the window is mounted in a vehicle. Preferably, the inner peripheral surface is also free of attachment to a supporting structure—in other words, the window assembly is a frame-less window assembly so that when the window assembly is mounted is a vehicle it can be mounted using a direct bonding method, such as by an adhesive, including a urethane adhesive or the like, which may be applied to the inner peripheral portion of the fixed pane adjacent the sliding pane supporting structure.

According to yet another aspect, the sliding pane is recessed with respect to the fixed pane—or has a “sub-flush” mounting when moved to its closed position.

It can be appreciated that the present invention provides an improved window assembly that is self-contained and modular in design and that is simpler to assemble and readily installed in an opening of a vehicle at a vehicle manufacturing plant. The window assembly provides an onboard motion imparting system for the sliding pane (or panes) that is contained in the modular assembly to further facilitate assembly at the vehicle manufacturing plant.

These and other objects, advantages, purposes, and features of the invention will become more apparent from the study of the following description taken in conjunction with the drawings.

### DESCRIPTION OF THE DRAWINGS

FIG. 1 is a front elevation view of a slider window assembly of the present invention;

FIG. 2 is a rear elevation view of the window assembly of FIG. 1;

FIG. 3 is an enlarged cross-section view taken along line III-III of FIG. 2;

FIG. 4 is an enlarged cross-section view taken along line IV-IV of FIG. 2;

FIG. 5 is an enlarged cross-section view taken along line V-V of FIG. 2;

FIG. 6 is a similar view to FIG. 3 illustrating another embodiment of the drive assembly of the present invention;

FIG. 7 is a view similar to FIG. 3 illustrating yet another embodiment of the drive assembly of the present invention;

FIG. 8 is a cross-section view taken along line VIII-VIII of FIG. 2;

FIG. 9 is a front elevation view of another embodiment of the slider window assembly of the present invention;

FIG. 10 is a rear elevation view of the window assembly of FIG. 9;

FIG. 11 is a cross-section view taken along line XI-XI of FIG. 10;

FIG. 12 is a front elevation view of yet another embodiment of the slider window assembly of the present invention;

FIG. 13 is a rear elevation view of the window assembly of FIG. 12; and

FIG. 14 is a perspective view of a window assembly of the present invention mounted in a rear opening of a truck.

### DETAILED DESCRIPTION OF THE PREFERRED EMBODIMENT

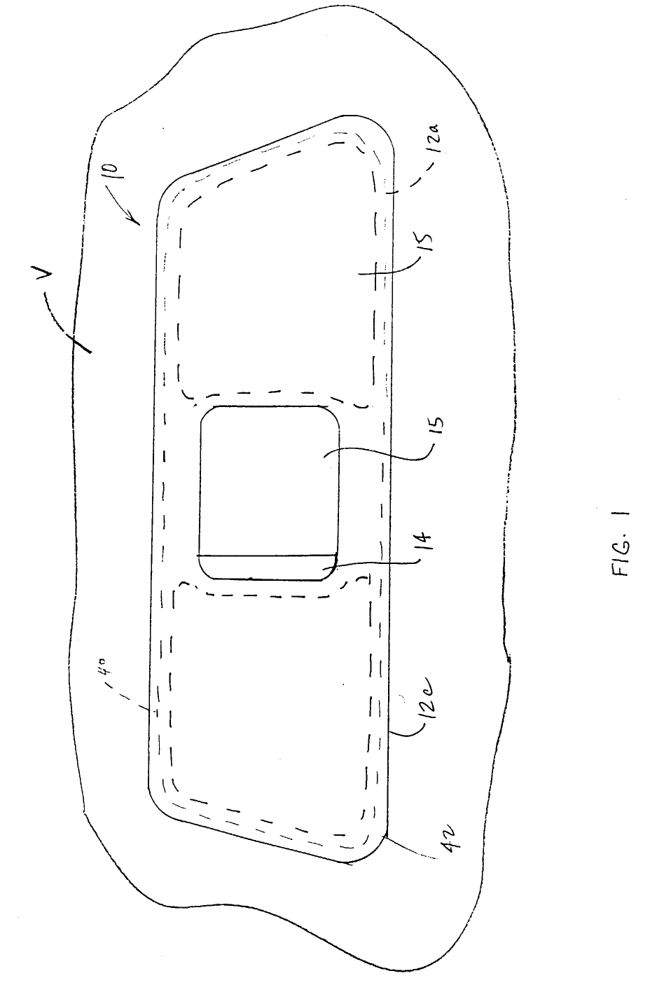

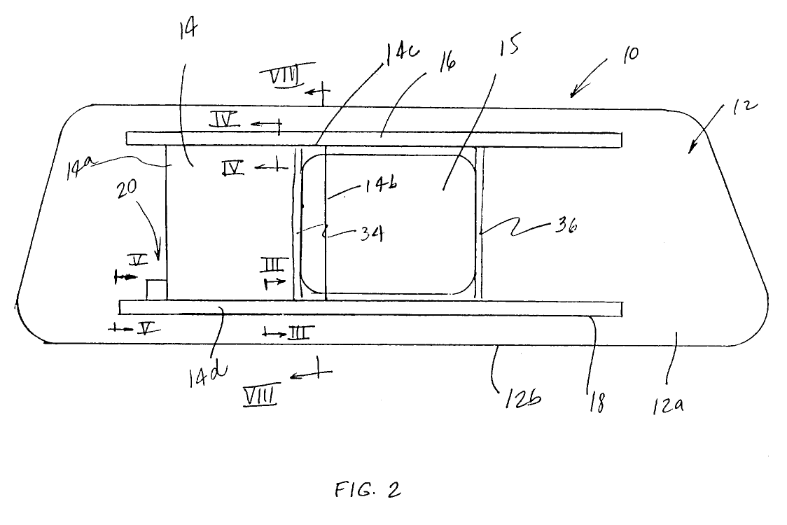

Referring to FIGS. 1 and 2, the numeral 10 generally designates a power slider window assembly of the present invention. Slider window assembly 10 is particularly suitable for use as a rear window or backlite of a vehicle, such as a light truck, including a pick-up truck or the like. As will be more fully described below, slider window assembly 10 comprises a self-contained modular assembly that incorporates an onboard motion imparting system for the sliding pane or panes so that assembly may be installed as a single unit in the vehicle, for example, at the vehicle manufacturing plant or as a replacement window assembly.

In the illustrated embodiment, window assembly 10 incorporates a single fixed pane 12 and a sliding pane 14. The fixed pane includes an opening 15 formed therein that is opened and closed by sliding pane 14, which is movably mounted to the inner surface 12a (FIG. 2) of fixed pane 12. Opening 15 is located inward or inboard of the perimeter 12b of fixed pane 12 such that fixed pane 12 has a continuous perimeter portion that extends around opening 15, such as described in copending U.S. patent application. Ser. No. 10/408, 047, which is herein incorporated by reference in its entirety. Though illustrated as being substantially centered in the fixed pane, opening 15 may be generally centrally located but offset to one side or the other or offset toward one of the edges. Preferably, the inner surface of the perimeter portion of fixed pane 12 provides a mounting surface inward of perimeter 12b for mounting window assembly 10 in an opening in a vehicle body by direct bonding with the vehicle body. For example, window assembly 10 may be mounted in the vehicle by a bead of adhesive that is located between the vehicle body panel and the inner surface of the perimeter portion of fixed pane 12 so as to provide a substantially flush mounting of window assembly 10 in the vehicle. Furthermore, perimeter edge 12c is preferably free of attachment so that the window appears to be floating in the opening of the vehicle body. As used herein “flush mounting” in reference to the position of the window assembly in the vehicle body means that at least the fixed pane appears to lay in the same plane as the vehicle body or, in the case of a curve vehicle body, lies in the curved plane of the vehicle body and generally follows the contours of the vehicle body.

In the illustrated embodiment, sliding pane 14 is supported for horizontal movement over opening 15 but it should be understood that the sliding pane may be supported for vertical movement using the same or similar principles described herein. Referring to FIG. 2, sliding pane 14 is guided and, preferably, supported by a guide, such as a pair of rails 16, 18 that are mounted to the rear surface 12a of fixed pane 12, for example by an adhesive. Alternately, rails 16 and 18 may be molded onto fixed pane 12. Each rail 16 and 18 provides or has formed therein a longitudinal channel or groove, which guides sliding pane 14. In the illustrated embodiment, the upper and lower traveling edges 14c, 14d of pane 14 extend into the respective grooves of rails 16 and 18. In this manner, when pane 14 is moved to its closed position over opening 15, pane 14 is offset inwardly from the plane of the fixed pane to form a “sub-flush” mounting arrangement for pane 14 with respect to fixed pane 12. As used above, the term “inwardly” refers to the relative position, for example, of the sliding pane with respect to the fixed pane when the window assembly is mounted in the vehicle. Similarly, references to “inner”, “outer”, and “exterior” are used as nomenclature relative to when the window assembly mounted in the vehicle.

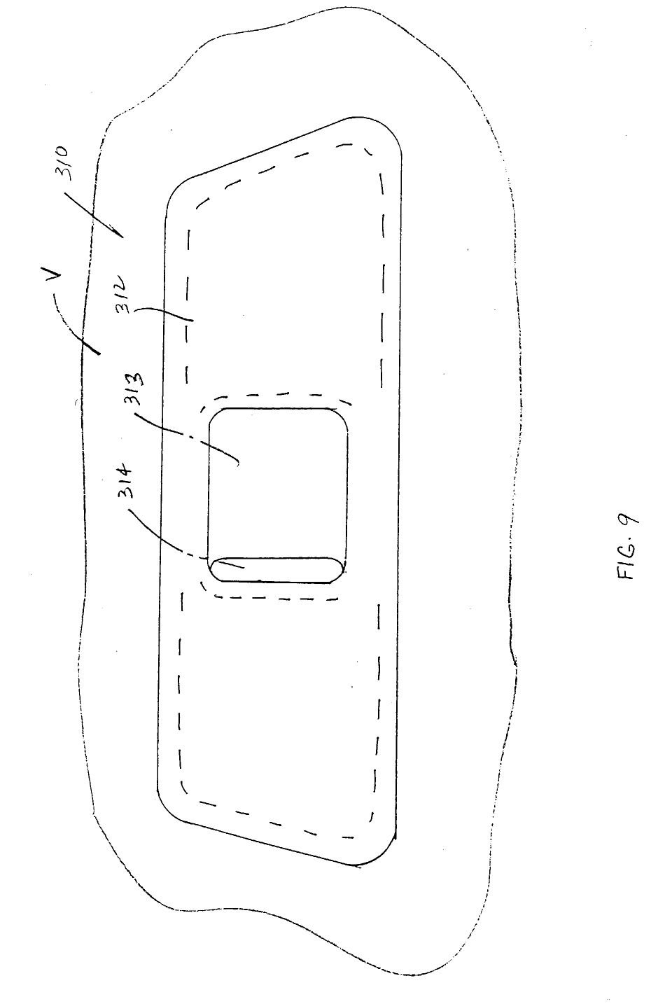

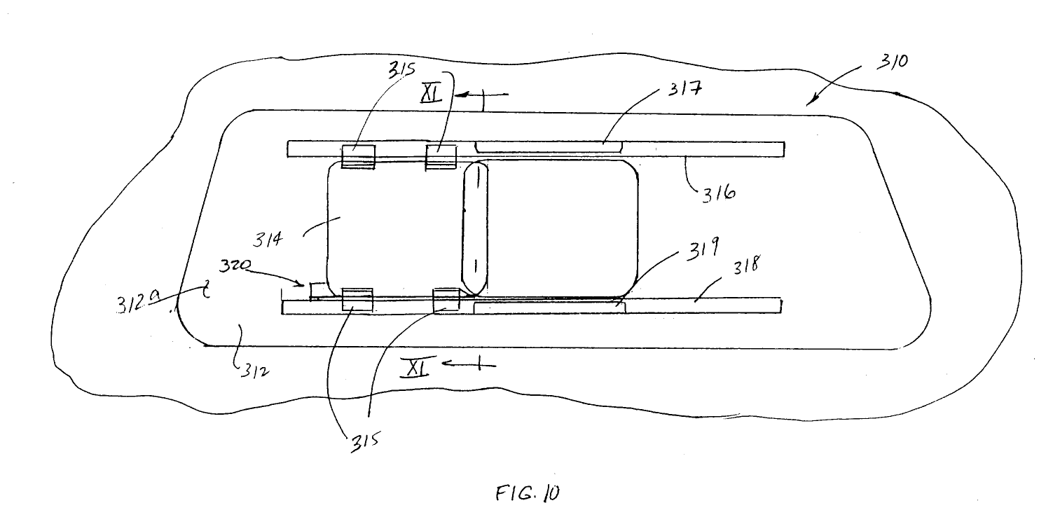

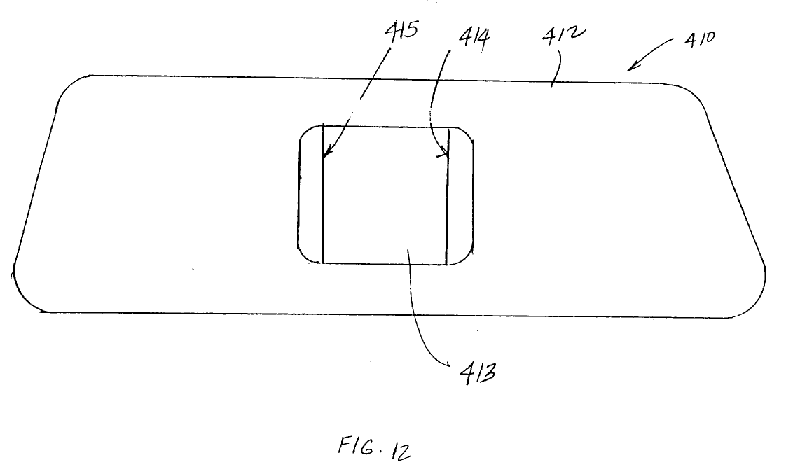

As noted above, in the illustrated embodiment window assembly 10 comprises a horizontal slider window assembly, with rail 16 comprising an upper horizontal rail and rail 18 comprising a lower horizontal rail, which are both mounted to the inner surface of fixed pane 12 and spaced apart to provide support to and guide the upper and lower edges of sliding pane 14. As will be more fully described in reference to FIGS. 9 and 10, the rails may alternatively guide and support attachments that are mounted to the sliding pane so as to permit a flush positioning of the sliding pane within the opening.

As noted above, rails 16 and 18 are mounted to the inner surface 12a of fixed pane 12 and may be mounted, for example, by an adhesive, such as a urethane adhesive, including a one part or two part urethane adhesive, an epoxy adhesive, an acrylic adhesive, a polyvinylbutyral adhesive, a silicone adhesive, or the like. Reference is made to U.S. Pat. Nos. 4,364,214; 4,364,595; 6,299,255; and 6,220,650 for examples of suitable adhesives, which are incorporated by reference in their entireties.

Sliding pane 14 is moved along rails 16 and 18 by an onboard motion imparting system or drive assembly 20. As noted above, drive assembly 20 preferably comprises an onboard drive assembly that is mounted inboard of the window assembly perimeter such that slider window assembly 10 is a self-contained modular power slider window assembly unit. Because drive assembly 20 is wholly inboard the perimeter edge of window assembly 10, drive assembly 20 can be installed at the window assembly manufacturing facility, which facilitates installation of the window assembly unit at the vehicle manufacturing facility or the like.

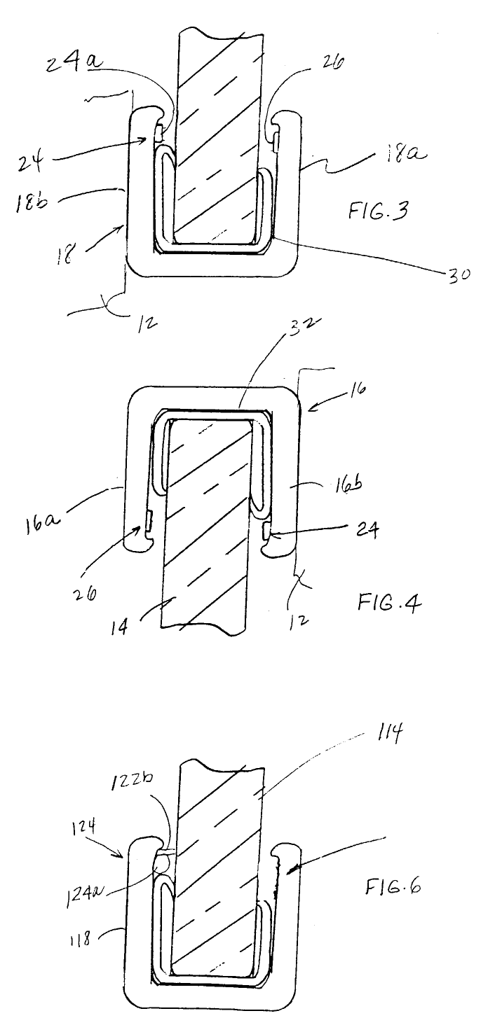

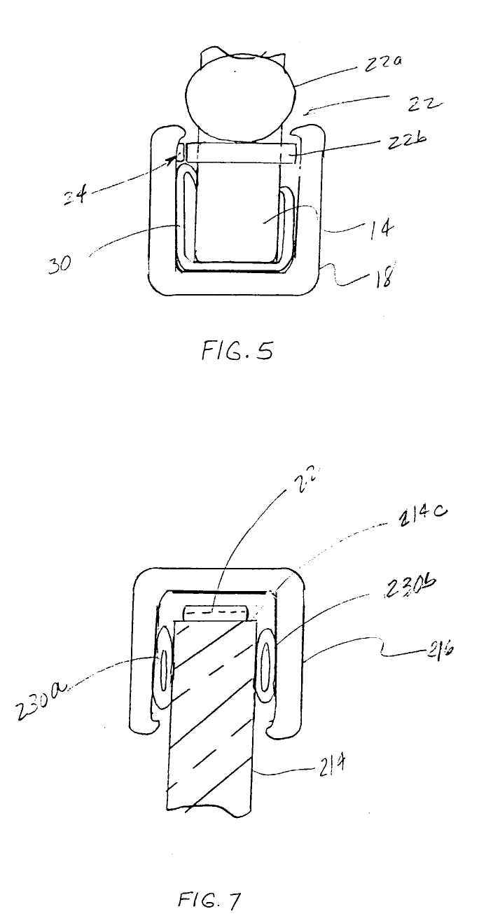

Drive assembly 20 includes a driver 22, such as a motor 22a and drive gear 22b, and a driven element 24. In the illustrated embodiment, driver 22 is mounted to sliding pane 14, for example, at or near a trailing edge 14a of sliding pane 14, for engaging driven element 24, which is mounted in a fixed relationship relative to fixed pane 12 so that when energized driver 22 will move sliding pane 14 relative to fixed pane 12. For example, driven element 24 may comprise a rack 24a (FIG. 3) or a worm 124a (FIG. 6) or the like, which is mounted at, in, or on one of the rails. Preferably, the driven element is mounted in one of the rails so that when the sliding pane is inserted into the rail the driver and driven element are engaged so as to drivingly couple the driver and the driven element to provide a more compact arrangement. Reference is made herein to U.S. Pat. No. 5,572,376 for an example of another drive mechanism arrangement that may be used herein. Alternately, the drive assembly may use a belt or tape drive arrangement, with the belt or tape at least partially contained in one of the rails and coupled to the sliding pane by a bracket or the like. The belt or tape is then driven by a motor that is mounted to the fixed pane, for example, preferably, in or on one of the rails so that the belt or tape imparts motion to the sliding pane.

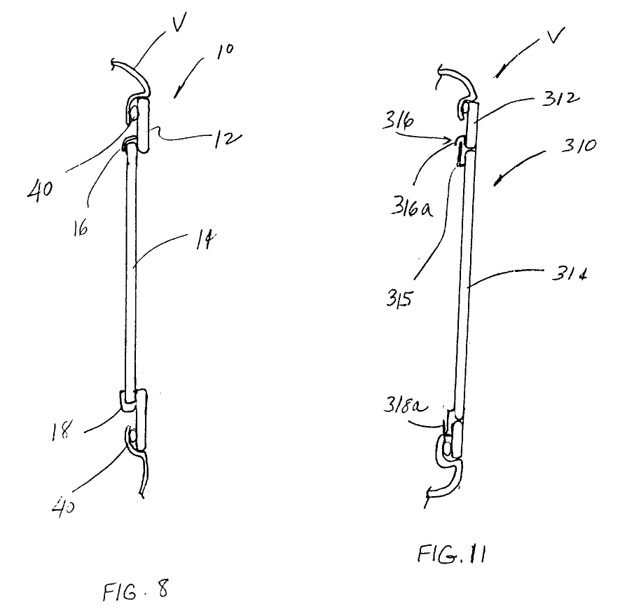

In the illustrated embodiment, driven element 22 is mounted in lower rail 18 and mounted to flange 18b of rail 18. However, it can be appreciated by way of reference to FIG. 7, the driven element may be mounted in upper rail 16, with the driver mounted at the upper end of trailing edge 14a of sliding pane 14, which would reduce the exposure of the driven element and the driver to debris and/or water. Similarly as described below, driver 22 may be mounted in a fixed position relative to fixed pane, while the driven element may be mounted to sliding pane 14.

Where driver 22 is mounted to the sliding pane, driver 22 may be powered through electrically conductive contacts 26, such as electrically conductive strips, provided on or in the respective rail, such as in lower rail 18, which are electrically coupled to a power supply, such as the vehicle ignition system. For example, contacts 26 may be coupled to the vehicle ignition system through a center high mounted signal light (CHMSL) or through electronically conductive tracings in or on fixed pane 12. Contacts 26 extend along lower rail 18 at least over the range of motion of the sliding pane and are contacted by electrically conductive contacts 28, such as electrically conductive contact brushes or fingers, of driver 22. Contacts 26 may be located on or in the inwardly facing side of flange 18a of rail or on the inwardly facing side of flange 18b of rail 18. For ease of illustration, FIG. 3 depicts contacts 26 on the opposed flange (18a) from the driven element; however, it should be understood that contacts 26 may be located on the same flange as driven element 24. Furthermore, as would be understood, where driver 22 is mounted to the upper end of trailing edge 14a of sliding pane 14, contacts 26 are preferably located in upper rail 16 and, again, may be located on or in either flange 16a and 16b of rail 16.

Thus, a power slider window assembly, such as a power rear window or backlite assembly, can be provided that can be used in a vehicle body window receiving opening without the need to accommodate any elements of the motive drive mechanism elsewhere in the vehicle body (such as typically indicated in U.S. Pat. Nos. 4,920,698; 4,995,195; 5,146,712; 5,531,046; and 6,119,401, for example, where there is a need to have cables or drivers located below the window assembly opening). The present invention instead therefore provides a self-contained unitary power slider window assembly. Also, a manual version of a slider window assembly can be converted to a powered slider window assembly by including one of the onboard motive elements described herein (such as by attachment to the sliding pane). A variety of motive elements may be used. For example, one or both rails guiding and supporting the movable sliding pane can include a powered sliding element (such as a powered belt, tape, or shuttle) to which the sliding pane attaches so that movement of the sliding pane can be achieved when required.

Alternately, driver 22 may be positioned in or above or below one of the rails (16 or 18), with the driven element mounted to the sliding pane. For example, as will be described in reference to FIG. 7, the driven element may be mounted to an upper edge of the sliding pane or the driven element may be mounted to the inner surface of the sliding pane, for example, adjacent the upper traveling edge of the sliding pane. Where driver 22 is mounted in the rail or to the fixed pane, driver 22 is optionally powered through wiring that extends through the rail and/or through electrically conductive tracings in or on fixed pane 12, similar to defrost tracings. Where the driver is located at the upper end of sliding pane 14, the driver may be powered through the wiring or tracings for a center-high mounted signal light (CHMSL) of the vehicle.

In addition, the actuation of driver 22 may be controlled by a remote control, such as a control located in the vehicle that may be hardwired to the circuit powering driver 22, or by a control mounted onboard the window assembly, including a control mounted to the driver, that is actuated by a switch or button that communicates with the control through radio frequency (RF) communication or via a bus system or hardwiring.

Referring to FIGS. 3 and 4, rails 16 and 18 comprise generally U-shaped or channel-shaped members with downwardly and upwardly depending flanges 16a, 16b and 18a, 18b, respectively. As noted above rails 16 and 18 are preferably bonded to the inner surface of fixed pane 12. Optionally flanges 16b and 18b may include recessed mounting surfaces for receiving an adhesive or the like for mounting rails 16 and 18 to fixed pane 12. It should be understood that rails 16 and 18 may have other configurations while still achieving the same guiding function for sliding pane 14. For example, the mounting flange (16b and 18b) may be truncated or eliminated, with the web of the rail providing the mounting surface, for example. Rails 16 and 18 are preferably formed from a rigid material, such as a polymeric material, including glass filled nylon, PVC, or the like. Rails 16 and 18 may also comprise a metal material or may comprise a composite material, such as a filled polymeric or a metal member that is encapsulated in plastic, for example. However, where the rail acts as an electrical conduit for the driver assembly, the rail is preferably a non-conductive material, such as a polymeric material.

In the illustrated embodiment, the upper and lower traveling edges 14c and 14d of sliding pane 14 extend into the respective channels or grooves provided by rails 16 and 18 so that pane 14 is guided and optionally supported therein for generally horizontal movement. In addition, seals 30, 32 are preferably positioned in the respective grooves of rails 16 and 18 to seal sliding pane 14. Seals 30, 32 may comprise generally U-shaped seals or comprise double-L seals, Y-seals, V seals, C-shaped seals, bulbous seals, or one of a number of different shaped-seals and preferably comprises a polypropylene material (PPE). Examples of suitable seals can be found in U.S. Pat. Nos. 6,220,650 and 6,299,235, which are incorporated by reference herein in their entireties.

When in the closed position, trailing and leading edges 14a and 14b of sliding pane 14 are sealingly engaged by seals 34 and 36, which may be mounted to the inner surface 12a of fixed pane 12, so as to provide a substantially full circumference seal around opening 15 when sliding pane 14 is moved to its closed position. Seals 34 and 36 may comprise Y-shaped seals or bulbous seals or one or more of the various other shaped seals noted above. Alternately, seals 34 and 36 may be mounted at the leading and trailing edges of sliding pane 14. Furthermore, seals 30, 32 and 34, 36 may be formed as a single unitary seal, such as an H-shaped seal to facilitate handling and installation, such as disclosed in U.S. Pat. Ser. No. 09/638,433, filed Aug. 14, 2000, entitled POWER SLIDER WINDOW ASSEMBLY (Attorney Docket No. DON02 P-823), which is herein incorporated by reference in its entirety. Alternately, seals 34 and 36 may be supported in generally vertical members, such as channel-shaped or L-shaped members, which interconnect upper and lower rails 16 and 18 to form a generally H-shaped sliding pane support assembly. The vertical members may be similarly formed from a plastic material, a metal material, or a composite material, similar to rails 16 and 18. In addition, the vertical members and rails 16 and 18 may be formed, such as by molding, as a single support assembly. Reference is made to copending application Ser. No. 10/113,056, filed Apr. 1, 2002, entitled HORIZONTAL SLIDER WINDOW ASSEMBLY, by David E. Nestell, Darin J. Snider, Loren B. Renkema, and Jim Galer (Attorney Docket No. DON02 P-965), which is incorporated by reference in its entirety. Alternately, as described in the referenced pending application, the seal or seals may be injection molded, for example from SANTOPRENE® brand polymeric material available from Monsanto Corporation or formed from other materials, including EPDM and thermoplastic elastomers. Furthermore, one or more of the seals may be molded with the individual support members or the support assembly, such as by co-injection or the like.

As previously noted, window assembly 10 is preferably directly bonded to the body of the vehicle by an adhesive, such as a urethane adhesive, including one part or two part urethane adhesive, an epoxy adhesive, an acrylic adhesive, a silicone adhesive, a polyvinylbutyral adhesive, or the like. As best seen in FIG. 3, a bead of adhesive 40 is applied to the inner peripheral surface of fixed pane 12 inward of perimeter 12b of fixed pane 12 and mounts fixed pane 12 to body of vehicle V. Preferably, bead 40 extends substantially around the full circumference of fixed pane 12 and directly contacts the inner surface 12a of fixed pane 12 (except where bead 40 wraps over downwardly depending tubes of rail 18 to thereby provide water passageways or channels from lower horizontal rail 18). In this manner, window assembly 10 provides a substantially continuous seal plane. In addition, rails 16 and 18 are mounted to fixed pane 12 substantially inward of bead 40. Optionally and preferably, adhesive bead 40 is spaced inwardly from perimeter 12b of fixed pane 12 so that outer perimeter edge 12c is free of attachment so that, as noted above, window assembly 10 appears to be floating in the opening of the vehicle body.

Referring again to FIG. 1, preferably, at least fixed pane 12 includes a frit layer 42 (FIG. 2), which extends around the outer peripheral portion of fixed pane 12 on inner surface 12a. Optionally and preferably, frit layer 42 also extends around opening 15 to thereby conceal the location of seals 34 and 36 and also any vertical support members that may be provided. Frit layer 42 is substantially opaque and, therefore, provides a concealing function and further facilitates the adhesion or bonding of fixed pane 12 to the vehicle body.

Referring to FIG. 6, the drive assembly may include a worm gear 122a as the drive gear 122 and a worm 124a as the driven element 124. Similar to the previous drive assembly, worm 124a is mounted in the rail and engaged by the worm gear, which is mounted to the drive shaft of the motor, which is turn is mounted to the sliding pane.

As previously noted, window assembly 10 may include a drive assembly with a driver 222 that is mounted in a fixed or stationary position relative to window assembly 10, such as in one of the rails, on top of or below one of the rails, or to the fixed pane. As best seen in FIG. 7, with a fixed or stationary drive assembly arrangement, driven element 224, such as rack 224a, may be mounted to the sliding pane 214. For example, driven element 224 may be mounted to upper traveling edge 214c, with the driver 222 positioned in rail 216. Alternately, the motor may be mounted on top of the rail with the driver gear extending through an opening provided in web 216c of rail 216 to thereby engage the driven element, which is mounted to the sliding pane. In addition, the driven element may be located on the side of the sliding pane or at or near the upper or lower trailing edge of the sliding pane. With several of these arrangements, sliding pane 214 may be sealed in the respective rail, such as rail 216, by a pair of seals 230a and 230b.

Referring to FIGS. 9 and 10, the numeral 310 designates another embodiment of the slider window assembly of the present invention. Window assembly 310 includes a single fixed pane 312, similar to fixed pane 12, and a sliding pane 314 that is mounted for horizontal movement to open and close opening 315, which is formed in fixed pane 312 similar to opening 15 of window assembly 10. In addition, window assembly 310 is preferably flush mounted in a vehicle body so that at least the fixed pane follows the contours of the vehicle body.

In the illustrated embodiment, sliding pane 314 is supported such that when it is moved to its closed position, sliding pane 314 will move into opening 313 such that sliding pane 314 is located between the perimeter edges of fixed pane 312 and, further, lies substantially in the same plane as fixed pane 312 so that sliding pane 314 is substantially flush with fixed pane 312. As best seen in FIG. 10, sliding pane 314 includes mounted at its inner surface adjacent each upper and lower traveling edges 314c and 314d one or more guides 315 that guide sliding pane along rails 316 and 318. In order to translate the sliding pane's sliding horizontal movement, which is initially generally parallel to fixed pane 312, into a lateral movement in a direction that is generally orthogonal to the horizontal movement of sliding pane 314, each rail 316, 318 includes a guide 317, 319. Each guide 317, 319 includes a tapered guide surface or camming surface that translates the horizontal motion of sliding pane 314 into lateral movement so that the sliding pane is pushed and moved into the opening and generally into the same plane as fixed pane 312.

Alternately, sliding pane 314 may be guided into its closed position by the shape of rails 316, 318 or mechanical devices, such as cams, located in the rails. For example, rails 316, 318 may be tapered along their longitudinal length with their inner flanges 316a, 318a moving closer to fixed pane 312 over the length of the rail so that when sliding pane 314 is moved generally horizontally in rail 318, flanges 316 and 318a will guide guides 315 to move sliding pane 314 forward relative to fixed pane 312 to move pane 314 into opening 313 between the inner peripheral edges of fixed pane 312, which define opening 315.

Similar to the previous embodiments window assembly includes a drive assembly 320 for moving sliding pane 314. In the illustrated embodiment, drive assembly 320 includes a driver 322 mounted to sliding pane 314, with the driven element 324 mounted in or on rail 318. As noted previously, it should be understood that driver 322 may be mounted to fixed pane 312 or in or on one of the rails, with the driven element mounted to the sliding pane. Furthermore, the driver and driven element may be located at either the upper end or lower end of sliding pane 314.

To seal sliding pane 314, a seal or seals may be provided on the fixed pane around the perimeter of opening 313 or provided on the sliding pane around the perimeter of the sliding pane or a combination of both-with one or more seals located on sliding pane 314 and one or more seals located on or at the fixed pane. Preferably, in this manner, when sliding pane 314 is pushed into opening 313 by the combination of the drive assembly and the guides or the rails, sliding pane 314 will press the seals against fixed pane or will press against the seals so as to provide a substantially full circumference seal around pane 314 when pane 314 is in its closed position. Suitable seals may include Y-shaped seals, bulbous seals or any of the seal shapes noted above.

In addition, to conceal brackets 315, sliding pane 314 may have a frit layer formed around its traveling edges, such as at its upper and lower edges in the case of a horizontal slider or at its right and left traveling edges in the case of a vertical slider. It should also be understood that the sliding pane may include a frit layer that extends around the entire perimeter of the sliding pane to also conceal the seals.

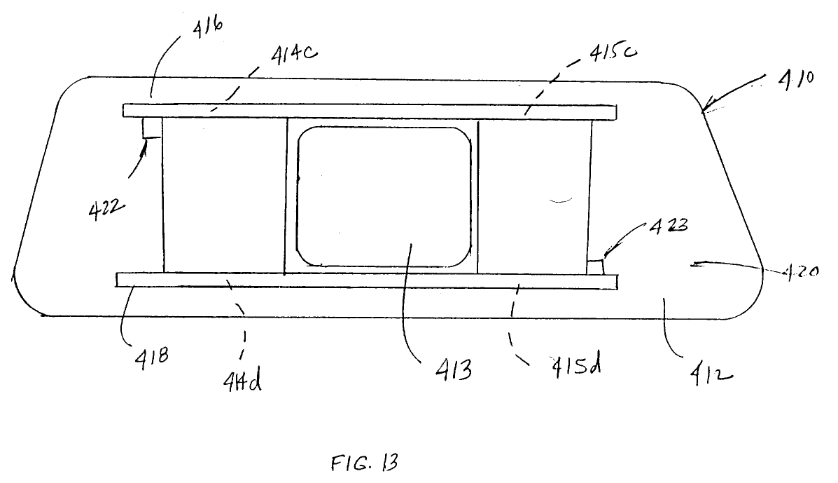

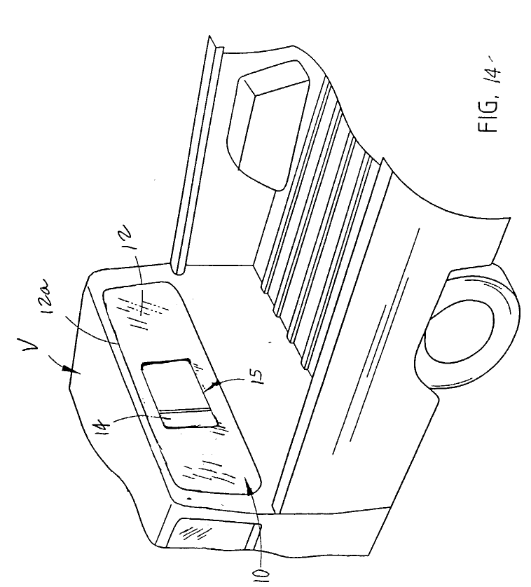

Referring to FIGS. 12 and 13, the numeral 410 designates another embodiment of the slider window assembly of the present invention. Window assembly 410 includes a single fixed pane 412, similar to fixed pane 12, and a pair of sliding panes 414 and 415 that are mounted for horizontal movement to open and close opening 413, which is formed in fixed pane 412 similar to opening 15 of window assembly 10. Similar to window assembly 10, window assembly 410 is preferably flush mounted in a vehicle body so that at least the fixed pane follows the contours of the vehicle body.

In the illustrated embodiment, sliding panes 414 and 415 are sub-flush with respect to fixed pane 412; however, it should be understood that panes 414 and 415 may be mounted with a flush arrangement with fixed pane 412 similar to pane 314. Panes 414 and 415 are commonly mounted to fixed pane 412 by a pair of rails 416 and 418, which are respectively mounted to inner surface 412a of fixed pane 412 by, for example an adhesive, similar to the previous embodiments. However, it should be understood that rails 416 and 418 may be molded onto fixed pane. Rails 416 and 418 similarly may comprise channel-shaped or L-shaped members and optionally and preferably include seals for sealingly engaging the upper and lower traveling edges 414c, 414d and 415c, 415d of sliding panes 414 and 415.

As best seen in FIG. 13, each sliding pane 414 and 415 is driven by drive assembly 420. In the illustrated embodiment, drive assembly 420 includes a driver 422 and 423 for each sliding pane. For examples of suitable drivers reference is made to the previous embodiments. Further, in the illustrated embodiment, driver 422 for sliding pane 414 is located at or near the upper traveling edge 414c of pane 414, while driver 423 is located at lower traveling edge 415d of pane 415. However, it can be appreciated that both drivers may be located on the same sides, such as at or near the upper traveling edges or at or near the lower traveling edges of the sliding panes. It can be appreciated that one of the sliding panes may be driven by drive assembly 422, while the other pane can be driven by the driven sliding pane, for example, by way of a cable system.

Though not illustrated, it should be understood that a latch mechanism may be incorporated into any of the window assemblies of the present invention. For example, the latch mechanism may be mounted to the sliding pane and with an engagement structure mounted the fixed pane. However, it should be understood that the parts may be switched—with the latch mounted to the fixed pane and the engagement structure mounted to the sliding pane. For examples of suitable latch mechanisms, reference is made herein to co-pending application Ser. No. 10/408,047, filed Apr. 4, 2003 (Attorney Docket DON02 P1083), which is herein incorporated by reference herein in its entirety.

As would be understood, the window assemblies of the present invention may be assembled as window assembly units that can be manufactured at a window assembly plant that is located remotely from a vehicle assembly plant. Furthermore, since the window assembly is supplied as a unit, it can be handled more easily, especially during installation at the vehicle assembly plant, where the window assembly unit is mounted in an opening or recess in the vehicle body. In addition, the window assemblies are configured so that they can be mounted in a vehicle body, preferably, with a generally flush mounting such that at least the fixed pane appears to lie in the same plane as the vehicle body or follow the contour of the vehicle body and, preferably, in a manner so the fixed pane appears to be floating in the vehicle body opening. Furthermore, as noted previously, the window assemblies may be mounted in the vehicle by direct bonding with the vehicle body.

The panes of window assemblies 10, 210, 310, and 410 preferably comprise transparent glass panes, including tinted transparent glass panes; however, it can be appreciated that the panes may be laminated or may comprise a polymeric pane, including a plastic pane. As would be understood from the foregoing, the fixed panes of the window assemblies preferably provide sufficient rigidity and support to the sliding pane or panes so that the window assemblies may be mounted in an opening of a vehicle as a unit while eliminating the need for a separate or integral support structure, such as a frame or the like, for the window assembly.

In addition, it should be understood that the window assemblies of the present invention may include a center high mounted stop light (CHMSL) mounted to the inner surface of the fixed pane above the sliding pane. The CHMSL may comprise a plurality of light emitting diodes (LEDs) or other light sources and is preferably attached to the inner surface of the fixed pane by an adhesive, such as the adhesives noted above.

It can be appreciated from the foregoing that the window assemblies of the present invention eliminate the need to make accommodations in the vehicle body for mounting or positioning any of the motive elements. In addition, the window assemblies of the present invention include fewer parts than conventional slider window assemblies and do not require studs or a gasket to be molded or otherwise adhered to the window assembly for mounting the window assembly in the vehicle body. As a result, the window assemblies of the present invention are simpler and easier to manufacture. Moreover, the window assemblies of the present invention allow for direct bonding of the fixed pane to the vehicle body.

While several forms of the invention have been shown and described, other forms will now be apparent to those skilled in the art. For example, while described in reference to a single, unitary fixed pane, the power slider window assemblies of the present invention may be assembled using two or more fixed panes, which are supported in spaced relationship by a support. In addition, while the seals are generally described as separate seals, which may be push fit into the rails or support members, it is further envisioned as noted that one or more seals may be combined as a single seal and/or integrally molded with the rails and/or the other sliding pane support members. Further, the window assemblies may incorporate post-attached structures, such as described in U.S. Pat. Nos. 5,352,010 and 5,451,090, which are incorporated by reference in their entireties, and accessories, such as storage compartments or the like mounted thereto, such as disclosed in U.S. Pat. No. 6,231,111, which is incorporated by reference herein in its entirety. For example, the window assemblies may incorporate lights, such as interior map lights or the like, or lights that direct exteriorly of the vehicle, such as brake lights (CHMSL), turn signals, or the like, which may be directly bonded to the fixed pane, such as by an epoxy adhesive, a silicone adhesive, a urethane adhesive, including a one-part and more preferable a two-part urethane adhesive, an acrylic adhesive, and a polyvinylbutyral adhesive, or the like. Therefore, it will be understood that the embodiments shown in the drawings and described above are merely for illustrative purposes, and are not intended to limit the scope of the invention which is defined by the claims which follow as interpreted under the principles of patent law including the doctrine of equivalents.

The embodiments of the invention in which an exclusive property right or privilege is claimed are defined as follows:

1. A vehicular power slider window assembly comprising:
at least one fixed pane defining an opening, said at least one fixed pane having an outer perimeter;
a sliding pane, said sliding pane adapted for sliding movement over said opening to thereby open and close said opening;
a drive assembly for moving said sliding pane to open or close said opening, said drive assembly including a driver and a driven element; and
a guide for guiding said sliding pane, said guide, said driver, and said driven element being mounted to said fixed pane inboard of said outer perimeter wherein said power slider window assembly comprises a self-contained power slider window assembly unit.

2. The slider window assembly according to claim 1, wherein said driver is mounted to said sliding pane.

3. The slider window assembly according to claim 2, wherein said driver comprises a motor and a drive gear.

4. The slider window assembly according to claim 3, wherein said driven element comprises a rack.

5. The slider window assembly according to claim 4, wherein said rack is mounted in a fixed position relative to said fixed pane.

6. The slider window assembly according to claim 5, wherein said rack is mounted in said guide.

7. The slider window assembly according to claim 1, wherein said driven element is mounted to said sliding pane.

8. The slider window assembly according to claim 7, wherein said driven element is mounted at or near an upper end of said sliding pane.

9. The slider window assembly according to claim 1, wherein said sliding pane is substantially flush with said fixed pane when said sliding pane closes said opening.

10. The slider window assembly according to claim 1, wherein said guide comprises a pair of rails.

11. The slider window assembly according to claim 10, wherein said pair of rails comprises a pair of rails positioned adjacent opposed sides of said opening for guiding said sliding pane.

12. The slider window assembly according to claim 10, wherein said pair of rails comprises horizontal rails for guiding said sliding pane in a horizontal direction wherein said sliding pane comprises a horizontal sliding pane.

13. The slider window assembly according to claim 12, wherein each of said horizontal rails includes a seal for sealing against said sliding pane.

14. The slider window assembly according to claim 12, wherein said pair of rails comprise channel-shaped rails.

15. The slider window assembly according to claim 14, wherein said sliding pane extends into said horizontal rails wherein said sliding pane comprises a sub-flush sliding pane.

16. The slider window assembly according to claim 1, further comprising seals mounted to said fixed pane for sealing with said sliding pane when said sliding pane closes said opening to thereby seal said opening.

17. The slider window assembly according to claim 10, wherein each rail of said pair of rails includes a groove formed therein, said groove for guiding the sliding pane.

18. The slider window assembly according to claim 17, wherein said groove is offset from said fixed pane and said sliding pane extends into said grooves wherein said sliding pane comprises a sub-flush sliding pane.

19. The slider window assembly according to claim 10, wherein said rails are mounted to said fixed pane by an adhesive.

20. The slider window assembly according to claim 1, wherein said fixed pane has an outer peripheral edge, further comprising a bead of adhesive applied to said fixed pane inwardly of said outer peripheral edge for securing said window assembly to a vehicle body wherein said window assembly appears to be floating in the vehicle body.

21. The slider window assembly according to claim 20, wherein said window assembly comprises a flush window assembly with at least said fixed pane substantially flush with the vehicle body when the window assembly is mounted in the vehicle.

22. A vehicular power slider window assembly comprising:
a fixed pane defining an opening, said fixed pane having an outer perimeter;
a sliding pane, said sliding pane being adapted for sliding movement over said opening to thereby open and close said opening and having a closed position when closing said opening;
a pair of rails for guiding and supporting said sliding pane, said rails being mounted to said fixed pane inboard of said outer perimeter and adapted to guide said sliding pane into said opening when said sliding pane is moved to its closed position wherein said sliding pane is substantially flush with said fixed pane when said sliding pane is moved to said closed position; and
at least one seal, said at least one seal extending around said opening and compressing when said sliding pane is moved to said closed position wherein said at least one seal provides a substantially full circumference seal around said sliding pane to thereby seal said opening when said sliding pane is moved to said closed position.

23. The slider window assembly according to claim 22, further comprising a drive assembly for moving said sliding pane to open or close said opening.

24. The slider window assembly according to claim 23, wherein said drive assembly includes a driver and a driven element, and said driver and driven element are mounted inboard of said perimeter edge of said fixed pane.

25. The slider window assembly according to claim 23, wherein said drive assembly includes a driver and a driven element, and said driver is mounted to said sliding pane.

26. The slider window assembly according to claim 25, wherein said driver comprises a motor and a drive gear.

27. The slider window assembly according to claim 26, wherein said driven element comprises a rack.

28. The slider window assembly according to claim 27, wherein said rack is mounted in one of said rails.

29. The slider window assembly according to claim 23, wherein said drive assembly includes a driver and a driven element, said driver being mounted in a fixed position relative to said fixed pane.

30. The slider window assembly according to claim 21, wherein said at least one seal is mounted to said fixed pane.

31. The slider window assembly according to claim 21, wherein said at least one seal is mounted to said sliding pane.

32. The slider window assembly according to claim 21, wherein said pair of rails comprises horizontal rails for guiding said sliding pane in a horizontal direction wherein said sliding pane comprises a horizontal sliding pane.

33. The slider window assembly according to claim 32, wherein each of said horizontal rails includes a seal for sealing against a traveling edge of said sliding pane.

34. The slider window assembly according to claim 32, wherein said pair of rails comprise channel-shaped rails.

35. The slider window assembly according to claim 21, wherein said fixed pane has an outer peripheral edge, further comprising a bead of adhesive applied to said fixed pane inwardly of said outer peripheral edge for securing said window assembly to a vehicle body wherein said window assembly appears to be floating in the vehicle body.

36. The slider window assembly according to claim 35, wherein said power slider window assembly comprises a flush power slider window assembly and said fixed pane is substantially flush with the vehicle body.
